(19) United States
(12) Patent Application Publication
(10) Pub. No.: US 2025/0355112 A1
(43) Pub. Date: Nov. 20, 2025

(54) USE OF A RADAR SENSOR HAVING A WAVEGUIDE ANTENNA ARRAY FOR A METHOD FOR DETERMINING AN ESTIMATED EGO VELOCITY VALUE AND AN ESTIMATED ANGLE VALUE OF TARGETS

(71) Applicant: Robert Bosch GmbH, Stuttgart (DE)

(72) Inventors: Thomas Binzer, Ingersheim (DE); Gor Hakobyan, Schoenaich (DE); Johannes Fink, Karlsruhe (DE)

(21) Appl. No.: 18/854,696

(22) PCT Filed: Mar. 29, 2023
(86) PCT No.: PCT/EP2023/058133

§ 371 Date: Oct. 7, 2024

(30) Foreign Application Priority Data
May 24, 2022 (DE) 10 2022 205 149.1

(51) Int. Cl. G01S 13/90; G01S 7/35; G01S 13/536; G01S 13/58; G01S 13/60; G01S 13/931

(52) U.S. Cl. CPC G01S 13/9019; G01S 7/356; G01S 13/536; G01S 13/583; G01S 13/586; G01S 13/60; G01S 13/931

(57) ABSTRACT

Use of a radar sensor with a waveguide antenna array, having at least two groups of antenna units having a plurality of antenna elements, wherein antenna elements in each antenna unit are arranged next to one another in a first direction, wherein, in a first group, the antenna units are arranged offset with respect to one another in a second direction perpendicular to the first direction, and wherein, in a second group, the antenna units are arranged offset with respect to one another in the first direction, for a method for determining an estimated ego velocity value and an estimated angle value of targets. In the method, using the radar sensor, a distance between the radar sensor and the respective target is in each case measured, and a relative velocity of the respective target is in each case measured using the Doppler effect.

### FIELD

The present invention is in the field of radar sensor technology and relates in particular to the fields of multiple-input multiple-output (MIMO) and synthetic aperture radar (SAR).

### BACKGROUND INFORMATION

Radar systems for measuring the distance, relative velocity and angle of objects are being used more and more in motor vehicles for safety and comfort functions. Nowadays, radar with multiple-input multiple-output (MIMO), that is, with multiple transmission channels for sending and receiving radar signals, is used for this purpose. Synthetic aperture radar (SAR) has recently become popular. The principle of synthetic aperture allows particularly accurate angle measurements when the radar sensor is in movement. The synthetic aperture uses the fact that the transmitting and receiving antennas are in different local positions at the time of each measurement due to the radar sensor's ego movement. The measurements are then processed into a synthetic antenna aperture. During evaluation, this can be equated with a large antenna aperture along the driving trajectory. This results in a large synthetic aperture, which would be impractical or even impossible with a real antenna aperture due to the large number of antenna elements required. SAR makes it possible to achieve higher resolutions in angle measurement than with real antenna apertures.

In order to evaluate the measured radar signals as a synthetic aperture, the radar environment is usually assumed to be stationary. In addition, the radar sensor's ego movement and thus the positions at which the individual measurements took place should be known. The trajectory of the radar flows into the SAR evaluation algorithm and forms the basis for calculating the SAR image. Depending on the evaluation algorithm, an estimated ego velocity value may be sufficient for calculating the SAR image instead of the more accurate trajectory. The trajectory is typically assumed to be linear, but more complex trajectories cannot be mapped.

Modern radar systems in the automotive sector generally use frequency-modulated continuous wave (FMCW) radar with rapidly increasing ramps-so-called fast chirp modulation—in which multiple linear frequency ramps with the same steep gradient are passed through sequentially. Mixing the instantaneous transmitted signal with the received signal produces a low-frequency signal (called beat frequency), the frequency of which is proportional to the distance. The system is usually designed in such a way that the part of the beat frequency caused by the Doppler frequency is negligible. The distance information obtained is largely unambiguous. In addition, a Doppler shift can be determined by observing the temporal development of the phase of the complex distance signal across the ramps and the relative velocity can be ascertained from this. The distance and relative velocity are ascertained independently of each other. As a rule, a two-dimensional Fourier transformation is used for this purpose.

Conventional SAR evaluation is based on stationary targets. Moving targets that do not fulfill this assumption lead to a faulty, angularly shifted and blurred image in the SAR image. However, moving targets are also of interest for motor vehicles (e.g. to avoid collisions with them). Two approaches are available for estimating the self-trajectory or ego velocity of the radar sensor: On the one hand, an external sensor, for example an inertial measurement unit (IMU) or an odometry sensor, is used. On the other hand, very computationally complex autofocus algorithms are used, which cannot be used for real-time processing.

### SUMMARY

The present invention relates to the use of a radar sensor with a waveguide antenna array, described in detail below, for a method for determining an estimated ego velocity value and an estimated angle value of a plurality of targets in the environment, the method steps of which are described in detail below.

According to an example embodiment of the present invention, the waveguide antenna array of the radar sensor has at least two groups of antenna units, wherein antenna elements in each antenna unit are arranged next to one another in a first direction. In a first group, the antenna units are arranged offset with respect to one another in a second direction perpendicular to the first direction. In a second group, the antenna units are arranged offset with respect to one another in the first direction. This creates a radar sensor with multiple-input multiple-output (MIMO).

According to an example embodiment of the present invention, the radar sensor uses digital beamforming (DBF) so that the antenna elements of an antenna unit can pick up and evaluate a radar signal together. The first group with the antenna units in the second direction is preferably used to measure the azimuth angle and the second group with the antenna units in the first direction is preferably used to measure the elevation angle.

According to an example embodiment of the present invention, in the second group, it may be provided that the antenna units are arranged offset with respect to one another only in the first direction. This leads to a reduced computing effort for digital beamforming. Optionally, the antenna units in the second group can also be arranged offset with respect to one another in the second direction. This enables measurement in the second direction for the second group and the radar sensor is designed for multiple-input multiple-output (MIMO).

According to an example embodiment of the present invention, preferably, the array groups are alternately assigned to either the transmitting side or the receiving side. According to the MIMO principle, transmitting and receiving antennas are, in principle, interchangeable.

A distinction is made below between stationary targets and moving targets. Stationary targets are objects in the environment that do not move themselves, for example buildings, trees, infrastructure on and along roads, etc. Moving targets are objects in the environment that are moving, for example other vehicles, pedestrians, other road users, etc.

According to an example embodiment of the present invention, the radar sensor moves, emitting a plurality of measurement signals and receiving signals that are reflected by targets. The radar sensor is therefore a radar sensor with a synthetic aperture. A relative velocity is ascertained for each target from the transmitted and received signals. To ascertain the relative velocity, the Doppler effect in the measurement signals is evaluated and, in particular, a Doppler shift is ascertained. In addition, a distance between the radar sensor and the target is also ascertained from the transmitted and received signals. This can be done using Fourier processing, for example. Detection with a constant false alarm rate (CFAR) is carried out to recognize the targets in the measurements.

According to an example embodiment of the present invention, a rough angle estimation is then carried out. An estimated angle value, which characterizes the target angle between the direction of the radar sensor's ego velocity, that is, the direction in which the radar sensor is moving (“forward direction”), and the respective target, is estimated for each target. The angle estimation can be carried out using digital beamforming, for example. For this purpose, the radar sensor has at least one additional receive channel and/or at least one additional transmit channel. Preferably, the estimated angle value directly indicates the target angle. However, the target angle can also be derived indirectly from a transformation or mathematical relationships from the estimated angle value. Since the estimated angle values are processed further later, the angle estimation can be significantly less accurate compared to conventional angle measurement.

According to an example embodiment of the present invention, an individual estimated ego velocity value for the radar sensor is calculated separately for each target by back projection using the relative velocity and the estimated angle value. This means that the measured or estimated values are used for each target in order to obtain an individual estimated ego velocity value for the radar sensor. Accordingly, a large number of individual estimated ego velocity values are typically ascertained, which are consequently dependent on the velocity of the target. For the stationary targets, the individual estimated ego velocity values are close to each other, as the relative velocity between the target and the radar sensor is proportional to the radar sensor's ego velocity and the target angle. For the moving targets, however, the individual estimated ego velocity values are further apart, as the relative velocity depends not only on the radar sensor's ego velocity and the target angle, but also on the velocity of the target. In addition, in a typical situation there are significantly more stationary targets in the environment than moving targets with the same relative velocity to the radar sensor and the moving targets normally have different velocities from each other.

This makes it possible to classify and subdivide the individual estimated ego velocity values, especially by clustering. For this purpose, a range for the individual estimated ego velocity values is defined, with which a distinction between stationary targets and moving targets is possible. Individual estimated ego velocity values that lie within a predefinable range around each other are assigned to stationary targets. Individual estimated ego velocity values that are outside the range are assigned to moving targets. This allows moving targets to be identified (MTI—moving target indication). The respective calculated individual estimated ego velocities can be included in a histogram for classification purposes, for example.

The individual estimated ego velocity values are then evaluated separately depending on the assignment. For the stationary targets, a combined estimated ego velocity value is ascertained from the individual estimated ego velocity values assigned to the stationary targets. The combined estimated ego velocity value can be regarded as the actual ego velocity of the radar sensor, as this was in principle calculated from only the stationary targets (autofocus). In addition, a corrected estimated angle value is calculated for the stationary targets using the combined estimated ego velocity value and the respective measured relative velocity. The corrected estimated angle value can be considered as the actual angle of the target with respect to the radar sensor.

The method of the present invention also allows the estimated ego velocity value and the estimated angle value to be determined directly from the measurements without the need for additional sensors, such as IMU or odometry sensors. The odometry sensors typically used in vehicles are usually positioned too far away from the radar sensor and also carry out too few measurements per time interval.

By using the radar sensor with waveguide antenna array for the described method of the present invention, a waveguide antenna is combined with MIMO and the SAR concept. The same antenna units or antenna elements are used for both MIMO and SAR. As a result, the number of channels of the radar sensor can be reduced, thus minimizing the antenna area. Reducing the number of channels is particularly advantageous for waveguide antennas, as these typically require a large installation space due to their three-dimensional structure and involve complex production.

The use of waveguide antennas achieves great flexibility in the arrangement of the antenna array elements. This makes it easy to achieve an advantageous λ/2 arrangement of the antenna units, which is advantageous both in terms of dynamics and a clear angle estimation.

According to an example embodiment of the present invention, to ensure that the radar signals received, downmixed and sampled in the baseband from the antenna array are compatible with the combination of MIMO and SAR, clear sampling of the Doppler frequency must be enabled. The following applies to the clearly detectable range of the radial component of the relative velocity v_{rel,r,u}:

$${v}_{rel , r , u} = {v}_{rel , r , max} - {v}_{rel , r , min} = \vert - {f}_{D , u} \vert \frac{c}{2 {f}_{c}} = \frac{c}{2 {f}_{c} {T}_{ctc}} \qquad ( Formula 1 )$$

v_{rel,r,max} and v_{rel,r,min} are the upper or lower limits of this range. f_{D,u} denotes the bandwidth of the maximum clearly detectable Doppler frequency, c denotes the wave propagation velocity, f_{c} the carrier frequency for the radar signal and T_{ctc} the duration between two frequency ramps (chirp-to-chirp) of the same transmitting antenna.

In time-division multiplexing, the duration between two frequency ramps T_{ctc} with a fixed bandwidth and fixed ramp slope or ramp duration increases with the number of transmitters, so that the number of transmitters is limited in conventional FMCW MIMO radar sensors based on time-division multiplexing. In the present invention, multiplexing is preferably carried out in the frequency dimension (FDM, frequency division multiplexing) or in the code dimension (CDM, code division multiplexing). For SAR, there are then no such limitations with regard to the number of transmitters.

Advantageously, according to an example embodiment of the present invention, the predefinable range used in the classification and subdivision of the individual estimated ego velocity values is an error tolerance range for the measurements. This is ascertained from the error for the measurement of the relative velocity and from the error for the angle estimation. This ensures that the division within the error limits is specific to the measurements and thus offers the greatest possible selectivity.

To determine the combined estimated ego velocity value, an averaged velocity value of the individual estimated ego velocity values can be calculated. A classic averaging, such as an arithmetic mean, a weighted averaging, for example with weights depending on the signal-to-noise ratio, a determination of the maximum in the histogram, a formation of a median, etc. can be carried out.

According to an example embodiment of the present invention, it is preferable to also ascertain a respective estimated angle value and a respective estimated velocity value for the moving targets. However, since the velocity of the moving target is not known, the evaluation described above would lead to an incorrect estimated angle value. The estimated angle value for the respective moving target can be the estimated angle value resulting from the above-mentioned angle estimation for this moving target. Although this does not improve the angle estimation, it does avoid incorrect angle estimation.

Furthermore, a radial estimated velocity value for the respective moving target can be ascertained from the relative velocity measured by means of Doppler shift. For this purpose, the combined estimated ego velocity value ascertained above is assumed to be the radar's ego velocity and subtracted from the relative velocity weighted by the cosine of the target angle.

The movements of both the radar and the moving targets are assumed to be two-dimensional in one plane. However, the target measured by the sensor may be at different heights in relation to the plane. This can occur in particular if, for example, only part of an object is detected. In this case, an elevation angle between the plane and the target can be ascertained for the target. Preferably, the elevation angle is taken into account for each target when ascertaining the individual estimated ego velocity value of the radar sensor using the relative velocity and the estimated angle.

Preferably, the radar sensor is a chirp sequence radar, which functions as a frequency-modulated continuous wave radar and emits chirp signals with rapidly increasing ramps. This makes it easy to measure the distance in a conventional manner. In addition, the Doppler effect, in particular the Doppler shift, can be determined from the temporal development of the phase of the complex distance signal over the ramps, and thus the relative velocity can be measured.

Conventional methods can be used to ascertain the relative velocity with the aid of the Doppler effect. Keystone processing based on the chirp Z-transform (CZT) is preferred here, as this is particularly computationally efficient and can compensate for any migration effects that occur.

### BRIEF DESCRIPTION OF THE DRAWINGS

Embodiment examples of the present invention are shown in the figures and explained in more detail in the following description.

FIG. 1 shows an isometric illustration of a waveguide antenna of a radar sensor used for the method according to the present invention.

FIG. 2 shows a schematic illustration of a traffic situation, with a vehicle with the radar sensor and various targets and associated angles and relative velocities.

FIG. 3 shows a flowchart of an embodiment example of the method of the present invention.

FIG. 4A shows a diagram of the distribution of individual estimated ego velocity values of the radar sensor for different targets.

FIG. 4B shows a histogram for the distribution from FIG. 4A.

FIG. 5 shows a location diagram of a trajectory generated using one embodiment of the method according to the present invention and a trajectory generated using an odometry sensor

### DETAILED DESCRIPTION OF EXAMPLE EMBODIMENTS

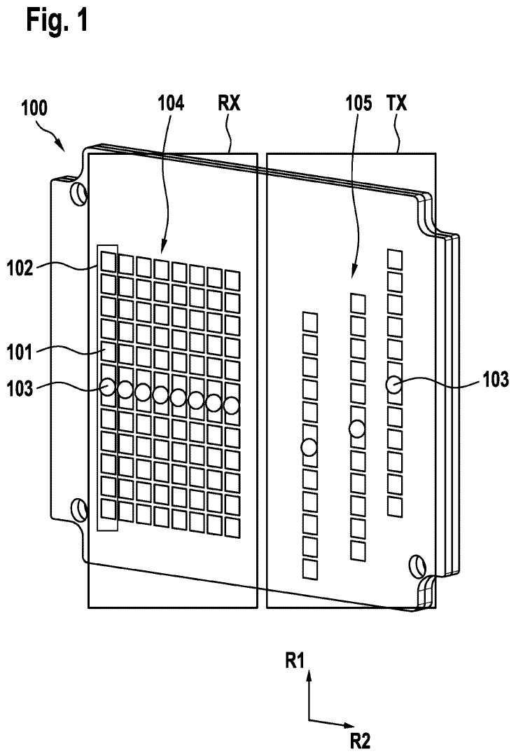

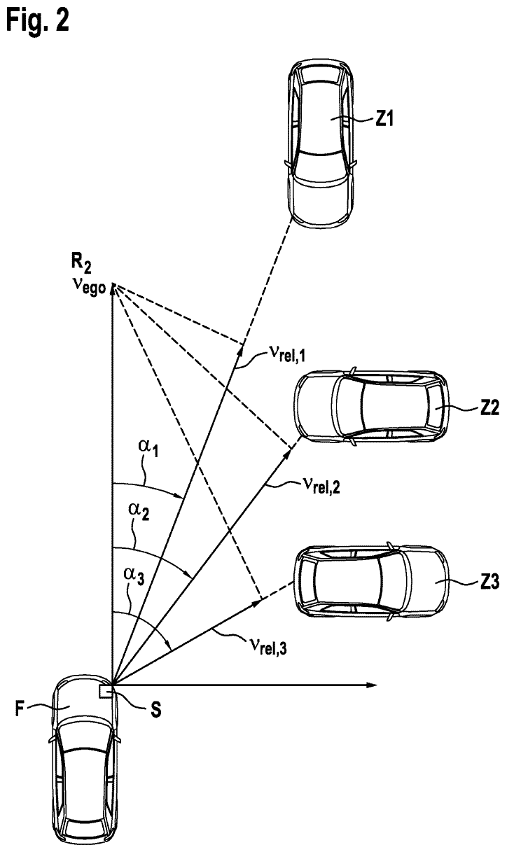

FIG. 1 shows a waveguide antenna 100 of a radar sensor S not shown in detail here. The waveguide antenna 100 has a waveguide antenna array consisting of multiple antenna elements 101. A plurality of antenna elements 101, in this example twelve each, are arranged in a column in a first direction R1 and together form an antenna unit 102 (in FIG. 1, an antenna unit is marked with a frame as an example). In this example, the first direction R1 corresponds to the vertical direction in a global reference system. The antenna elements 101 of an antenna unit 102 together transmit and receive radar signals. In FIG. 1, the phase centers 103 are marked for each antenna unit 102. The antenna units 102 of the waveguide antenna array are subdivided into two groups 104, 105. In this example, the first group 104 comprises eight antenna units 102, each of which has twelve antenna elements 101 arranged in columns in the first direction R1. In the first group 104, the antenna units 102 are arranged offset with respect to one another in the second direction R2. In this example, the second direction R2 corresponds to one of the horizontals in a global reference system and in this example, as shown in FIG. 2, runs in the direction of the ego velocity v_{ego} of a vehicle F that has the radar sensor S. In general, the second direction R2 can also be at an angle to the ego velocity v_{ego} of the vehicle F. As a result, only the antenna lobe is swiveled. The second direction R2 is associated with the azimuth angles α₁, α₂, α₃ and the first group 104 of antenna units 102 is used to measure the azimuth angles α₁, α₂, α₃. In this example, the second group 105 comprises three antenna units 102, which in turn each have twelve antenna elements 101 arranged in columns in the first direction R1. In the second group 105, the antenna units 102 are arranged offset with respect to one another in both the first direction R1 and the second direction R2. The second group 105 of the antenna units 102 serves to measure the elevation angles Φᵢ and to measure the azimuth angles α₁, α₂, α₃. In the state shown here, the first group 104 of the antenna units 102 is assigned to the receiving side RX and the second group 105 of the antenna units 102 is assigned to the transmitting side TX. The radar signals received by the first group 104 are processed by means of digital beamforming. However, the assignment can also be changed so that the first group 104 is assigned to the transmitting side TX and the second group 105 is assigned to the receiving side RX. The waveguide antenna 100 is thus designed for MIMO. In other embodiment examples not shown, in the second group 105, the antenna units 102 may be arranged offset with respect to one another only in the first direction R1. This simplifies two-dimensional digital beamforming. The radar sensor S with the described waveguide antenna 100 or the described waveguide antenna array is used for the method described below.

FIG. 2 shows a schematic illustration of a traffic situation, with a vehicle F carrying a radar sensor S with a waveguide antenna 100 described above, and multiple other vehicles designated as targets Z1 to Z3. Typically, there are other targets in the vicinity that are not shown here, such as buildings, the infrastructure of the road, i.e. traffic signs, guard rails, and the like, or the road itself. The vehicle F and thus also the radar sensor S move along a straight line with an ego velocity v_{ego}. From the radar sensor S, the azimuth angle α₁, α₂, α₃ between the direction of the ego velocity v_{ego} and the direction of the respective target Z1, Z2, Z3 is displayed for each target Z1, Z2, Z3 shown. In addition, the relative velocity v_{rel,1}, v_{rel,2}, V_{rel,3} Of each target Z1, Z2, Z3 in relation to the radar sensor S is shown. If one of the targets, for example target Z1, is a stationary target, i.e. it is not moving, the associated relative velocity v_{rel,1} is given as a projection of the ego velocity v_{ego} of the radar sensor S onto the associated azimuth angle α₁. The projections are shown in FIG. 1 for all three targets Z1, Z2, Z3. For a moving target, for example target Z2, which is moving at an unknown velocity, the velocity of target Z2 is part of the relative velocity v_{rel,2} and the measured relative velocity v_{rel,2} deviates from the projection.

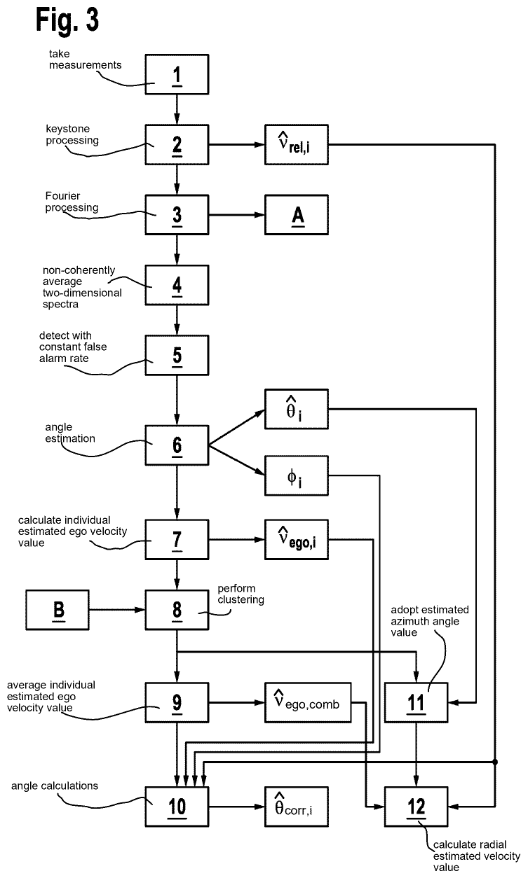

FIG. 3 shows a flowchart of an embodiment example of the method according to the present invention. A plurality of targets, generally referred to here as i, are examined. Measurements 1 are taken while the vehicle F and the radar sensor S are moving. The measurements 1 are carried out using frequency-modulated continuous wave radar modulation (FMCW), in which chirp signals with rapidly increasing linear frequency ramps of the same slope are emitted at predetermined time intervals. The reflected signals are recorded and processed as received signals. Mixing the instantaneous transmitted signal with the received signal produces a low-frequency beat signal the frequency of which is proportional to the distance to the target i. Measurements 1 are carried out in such a way that the Doppler effect or the Doppler shift in the beat frequency is negligible or is taken into account in the evaluation.

Keystone processing 2 is then carried out. This involves estimating the Doppler shift or Doppler frequency by determining the temporal development of the phase of the complex measurement signals across the frequency ramps and compensating the corresponding linear change in distance (migration) for each estimated value. As a result, relative velocities \hat{v}_{rel,i} are ascertained for each target i. The distance is then estimated using conventional Fourier processing 3, in particular a Fast Fourier Transform (FFT) from the time domain to the frequency domain. The generated two-dimensional spectra (distance and relative velocity) of the individual transmit-receive channel combinations are non-coherently averaged 4. For this purpose, the magnitude of each of these spectra is formed and these magnitudes or their magnitude squares are then summed. Detection with a constant false alarm rate (CFAR) 5 is used to recognize the targets in the measurements.

Furthermore, an angle estimation 6 is carried out in which estimated azimuth angle values \hat{θ}ᵢ are ascertained for the targets. The estimated azimuth angle value \hat{θ}ᵢ represents the azimuth angle between a measurement axis of the radar sensor S and the target i and thus also reflects the installation situation of the radar sensor S. Since the installation situation is known, the estimated azimuth angle value \hat{θ}ᵢ can be converted into an estimated value for the azimuth angle αᵢ between the direction of the ego velocity v_{ego} and the direction of the target i by coordinate transformation. In the case shown in FIG. 2, the measuring axis is perpendicular to the direction of the ego velocity v_{ego}. This results in the following correlation: \hat{θ}ᵢ=90−αᵢ. Digital beamforming is used for the angle estimation 6. Simultaneous measurements are taken across the multiple antenna units 102 on the waveguide antenna array and a phase difference is calculated, from which the estimated azimuth angle value \hat{θ}ᵢ can then be ascertained. The influence of the ego velocity v_{ego} of the radar sensor S is negligible for this type of angle estimation, so that the estimated azimuth angle values \hat{θ}ᵢ are ascertained independently of the ego velocity v_{ego} of the radar sensor S. The angle estimation 6 also includes ascertainment of an elevation angle ϕᵢ between the plane in which the vehicle is moving and the height at which the target i is detected.

For each target i, the relative velocity \hat{v}_{rel,i}, the estimated azimuth angle value \hat{θ}ᵢ and, if applicable, the elevation angle ϕᵢ are thus known. An individual estimated ego velocity value v_{ego},i is thus calculated 7 separately for each target i according to formula 2:

$${\hat{v}}_{ego , i} = \frac{{\hat{v}}_{rel , i}}{sin {\hat{θ}}_{i} \cdot cos {ϕ}_{i}} \qquad ( Formula 2 )$$

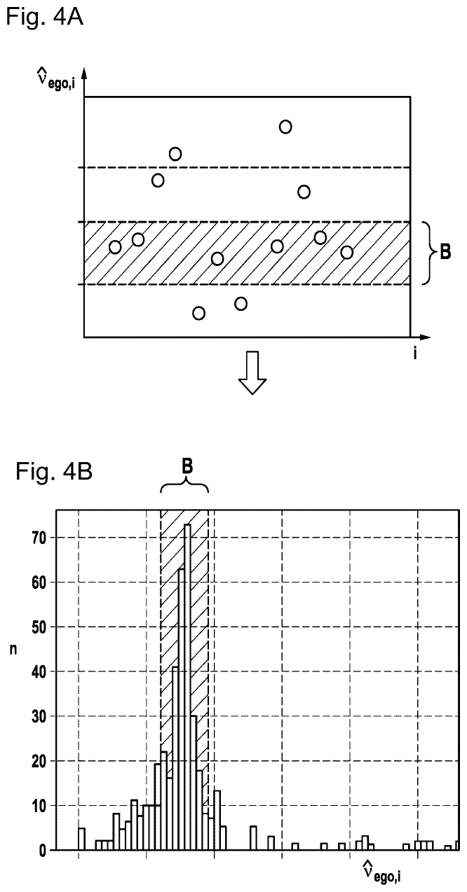

FIG. 4A shows a diagram of the individual estimated ego velocity values \hat{v}_{ego,i} calculated in this way for some targets i. FIG. 4B shows a histogram in which the ascertained number n is plotted for a plurality of different individual estimated ego velocity values \hat{v}_{ego,i}. In both figures it can be seen that the individual estimated ego velocity values \hat{v}_{ego,i} accumulate in an area B. In a typical traffic situation, there are significantly more stationary targets than moving targets with the same relative velocity radial to the radar sensor S.

With reference to FIG. 3, a clustering 8 is performed in which the individual estimated ego velocity values \hat{v}_{ego,i} that are within the range B are assigned to stationary targets and the individual estimated ego velocity values \hat{v}_{ego,i} that are outside the range B are assigned to moving targets. Thus the moving targets are identified (MTI—moving target Indication) and separated from the stationary targets. Range B is defined by the errors in measurement 1 and angle estimation 6 and represents an error tolerance range.

The individual estimated ego velocity values \hat{v}_{ego,i} associated with the stationary targets, i.e., located within the range B, are averaged 9 to obtain a combined estimated ego velocity value \hat{v}_{ego,komb}. Different types of averaging can be performed, for example a classical averaging, such as an arithmetic mean, a weighted averaging, for example with weights depending on the signal-to-noise ratio, a determination of the maximum in the histogram, a formation of a median, etc. Since the combined estimated ego velocity value \hat{v}_{ego,comb} was calculated, in principle, without the moving targets, it can be regarded as an estimated value \hat{v}_{ego} for the actual ego velocity \hat{v}_{ego} of the radar sensor S. This achieves autofocus. For each stationary target, an angle calculation 10 is also performed from the relative velocity \hat{v}_{rel,i} for the stationary target ascertained by the keystone processing 2 with the aid of the Doppler effect and the calculated individual estimated ego velocity value \hat{v}_{ego,i} for the stationary target using formula 3:

$${\hat{θ}}_{corr , i} = arcsin ( \frac{{\hat{v}}_{rel , i}}{{\hat{v}}_{ego} cos {ϕ}_{i}} ) \qquad ( Formula 3 )$$

Consequently, a corrected estimated angle value \hat{θ}_{corr,i} is calculated, which can be considered as the actual azimuth angle of the target with respect to the radar sensor S.

For the moving targets, however, the angle calculation 10 described above would lead to an incorrect angle estimation, as the velocity component of the moving target is unknown and therefore cannot be taken into account. Consequently, for a moving target, the estimated azimuth angle value \hat{θ}ᵢ ascertained during the angle estimation 6 is adopted 11. Although this does not improve the angle estimation, it does avoid incorrect angle estimation. Finally, a radial estimated velocity value of the moving target can be calculated 12 by subtracting from the relative velocity \hat{v}_{rel,i} ascertained by the keystone processing 2 with the aid of the Doppler shift the combined estimated ego velocity value \hat{v}_{ego,comb} ascertained for the stationary targets by averaging 9 weighted by the cosine of the azimuth of this target.

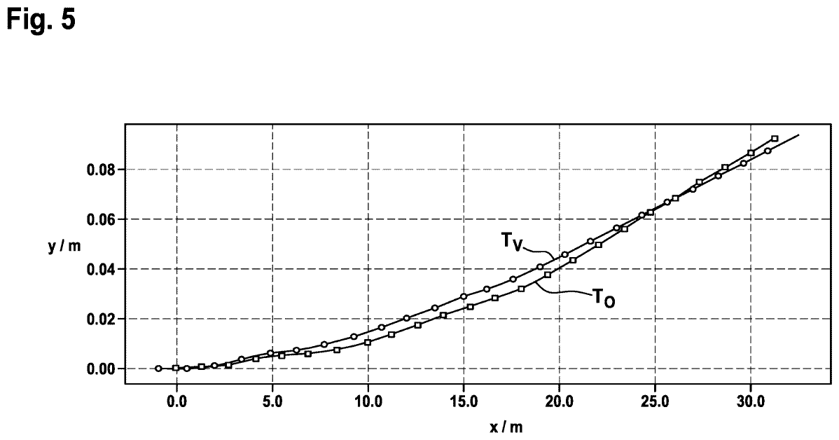

FIG. 5 shows a comparison between an odometry trajectory Tₒ, which was ascertained conventionally using an odometry sensor, and a trajectory Tᵥ, which was generated using an embodiment of the method according to the present invention. It can be seen that the two trajectories match very well and thus the autofocus using the method according to the present invention provides precise results.

1-10. (canceled)

11. A method for determining an estimated ego velocity value and an estimated angle value of targets using a radar sensor with a waveguide antenna array, having at least two groups of antenna units having a plurality of antenna elements, wherein the antenna elements in each of the antenna units are arranged next to one another in a first direction, wherein, in a first group of the at least two groups of antenna units, the antenna units are arranged offset with respect to one another in a second direction perpendicular to the first direction, and wherein, in a second group of the at least two groups of antenna units, the antenna units are arranged offset with respect to one another in the first direction, the method comprising the following steps:
measuring using the radar sensor, a distance between the radar sensor and each respective target;
measuring, using the radar sensor, a relative velocity of each respective target using a Doppler effect;
estimating a respective estimated angle value characterizing an angle between a direction of the radar sensor's ego velocity and each respective target;
ascertaining an individual estimated ego velocity value of the radar sensor using the relative velocity and the estimated angle value for each target;
classifying and subdividing the individual estimated ego velocity values in regard to stationary targets, the individual estimated ego velocity values of which lie within a predefinable range with respect to one another, and in regard to moving targets, the individual estimated ego velocity values of which lie outside the range;
ascertaining a combined estimated ego velocity value from the individual estimated ego velocity values of the stationary targets; and
ascertaining a corrected estimated angle value for each of the stationary targets using the combined estimated ego velocity value and the respective measured relative velocity.

12. The method according to claim 11, wherein, in the second group, the antenna units are additionally arranged offset with respect to one another in the second direction.

13. The method according to claim 11, wherein the at least two groups are alternately assigned to either the transmitting side or the receiving side.

14. The method according to claim 11, wherein the predefinable range is an error tolerance range ascertained from an error for the measurement of the relative velocity and from an error for the angle estimation.

15. The method according to claim 11, wherein an averaged velocity value for the stationary targets is determined as the combined estimated ego velocity value by weighted or unweighted averaging.

16. The method according to claim 11, wherein, for each moving target, the estimated angle value resulting from the angle estimation is adopted as the estimated angle value for the moving target.

17. The method according to claim 11, wherein an estimated velocity value for each moving target is ascertained from the relative velocity of the target measured using the Doppler effect.

18. The method according to claim 11, wherein an elevation angle is taken into account when ascertaining the individual estimated ego velocity value of the radar sensor using the relative velocity and the estimated angle value for each of the targets.

19. The method according to claim 11, wherein the radar sensor is a chirp sequence radar.

20. The method according to claim 11, wherein the ascertainment of the relative velocity is carried out using the Doppler effect using keystone processing.
